(19) United States
(12) Patent Application Publication
(10) Pub. No.: US 2004/0163372 A1
(43) Pub. Date: Aug. 26, 2004

(54) Environmentally friendly air filter for an internal combustion engine

(76) Inventor: Ledu Q. Nguyen, Fayetteville, NC (US)

Correspondence Address: BAKER & DANIELS, 300 NORTH MERIDIAN STREET, SUITE 2700, INDIANAPOLIS, IN, 46204-1782, US

(21) Appl. No.: 10/374,357

(22) Filed: Feb. 25, 2003

(51) Int. Cl. B01D 46/00

(52) U.S. Cl. 55/497; 55/498; 55/502

(57) ABSTRACT

The present invention involves an air filter that includes a filter medium having an inlet surface and an outlet surface, and a retaining screen made of a thermoplastic polymer that defines a plurality of apertures and is adjacent to and in communication with the outlet surface. A mold gasket maintains the retaining screen in fluid communication with the outlet surface. In another embodiment of air filter of the present invention, the air filter includes first and second end caps and the filter medium substantially extends between the first and second end caps. In this embodiment, the air filter includes at least one of an inner and an outer retaining screen, or both. The inner retaining screen defines a plurality of apertures and is adjacent to and in communication with the outlet surface, and the outer retaining screen defines a plurality of apertures and is adjacent to and in communication with the inlet surface. In this embodiment of the air filter of the present invention, at least one of the inner and outer retaining screens is made of a thermoplastic polymer.

### BACKGROUND OF THE INVENTION

1. Field of the Invention

The present invention relates to air filters for internal combustion engines, specifically air filter retaining screens.

2. Description of the Related Art

The internal combustion (“IC”) engine is an important part of an automobile. The IC engine's intake port delivers air to a combustion chamber where it is mixed with fuel and ignited. The controlled explosion resulting from the combination of air, fuel and spark provides a thrust on a piston, and the piston provides power to the automobile. The amount of air that flows to the engine is an important factor in the engine's power and efficiency.

It takes from 40,950 to 45,500 liters of air for each liter of fuel that propels today's cars. Air for combustion enters an automobile's IC engine through an air filter designed to protect the engine from foreign particles. Because the quantity of air flowing into the IC engine is typically substantial, measures must be taken to ensure that the air is clean and presents as little harmful material to the engine as possible. Air filter arrangements are therefore commonly utilized upstream of the IC engine with respect to air flow to protect the engine from foreign particulate matter carried by the air. Automotive air filters also are applied to filter cabin air.

Air filters typically include retaining screens that cover the air filter's filtering medium. The retaining screens serve to retain the filtering medium within the air filter and, in most instances, the screens are positioned downstream of the air filter medium. Most importantly, at the time in which the air stream flows through the retaining screens and into the IC engine, the air stream has already been filtered by the filtering medium.

Retaining screens are made of woven metal, perforated metal, or expanded metal. The use of metal screens is disadvantageous for several reasons. First, the weather conditions under which automobiles are frequently driven, e.g., rain, fog and humid weather, subject the metal retaining screens to moist air capable of corroding the screens. In other instances, the salt sprinkled on roads to prevent water from freezing is swept up in the air streams and subsequently filtered by automobile filters. An automobile's continuous filtering of salt-polluted air eventually corrodes the metal retaining screens. The corrosion of the metal retaining screens, whether caused by moist air or road salt, has the effect of causing the screens to flake, rust or both. Because the retaining screens are downstream of the air filter medium, the metal-laden air flows into the IC engine.

The metal flakes and rust that result from the corrosion of the metal retaining screens used in automotive air filters also may contaminate important sensors downstream of the air filters. For example, the Mass Air Flow (MAF) sensor, an important component involved in an automobile's fuel/air delivery system, is used to measure the amount of air that the IC engine is consuming by monitoring the air flow. Information provided to an automobile's control computer by the MAF is utilized by the computer to maintain the proper air/fuel mixture to ensure an efficiently operating engine. When the MAF sensor is contaminated, the sensor becomes dysfunctional and operates incorrectly. Consequently, the automobile's computer maintains an improper air/fuel mixture and causes the engine to operate inefficiently. Specifically, if there is not enough fuel mixed with the air, the engine “runs lean,” in which case it either does not run or is damaged. If there is too much fuel mixed with the air, the engine “runs rich” and either floods and does not run or runs smoky, poorly and wastes fuel.

The use of metal screens in automotive air filters further prevents the easy disposal of used air filters. Automotive air filters can not be incinerated because the metal retaining screens do not easily burn. The user of the air filter is left to dispose of the metal screens in landfills, thereby detracting from the environment by using up already limited landfill space and natural fossil fuel resources. Additionally, because the air filters contain the metal retaining screens, the user or recycler of the air filter must incur the labor costs of stripping and separating the metal from other waste materials if the retaining screens are to be separated for reuse or recycling.

The use of metal retaining screens in automotive air filters also adds unnecessary weight to the air filter. For this reason, the use of a lighter material in making retaining screens would provide weight savings. As made evident by the disadvantages of using metal retaining screens in automotive air filters, a retaining screen is needed in the art to improve over metal screens.

### SUMMARY OF THE INVENTION

In view of the foregoing disadvantages inherent in the use of metal screens in automotive air filters, the present invention provides a thermoplastic polymer retaining screen and an air filter including a thermoplastic polymer retaining screen.

In one embodiment of the present invention, an air filter includes a pleated filter medium having an inlet surface and an outlet surface. The inlet surface is positioned upstream of the outlet surface and provides an inlet for particulate matter to enter the air filter. The outlet surface provides an outlet for filtered air to exit the air filter. The air filter also includes a thermoplastic polymer retaining screen that defines a plurality of apertures and is positioned adjacent to the outlet surface so as to be in fluid communication with the outlet surface. The air filter further includes a mold gasket for maintaining the retaining screen in fluid communication with the outlet surface.

In another embodiment of the present invention, an air filter includes a pleated filter medium that substantially extends between a first and a second end cap, and the filter medium has an inlet surface positioned upstream of an outlet surface. The inlet surface provides an inlet for particulate matter to enter the air filter, and the outlet surface provides an outlet for filtered air to exit the air filter. The air filter also includes an inner retaining screen that extends between the first and second end caps. The inner retaining screen defines a plurality of apertures and is positioned adjacent to the outlet surface so as to be in fluid communication with the outlet surface. The air filter further includes an outer retaining screen that extends between the first and second end caps and defines a plurality of apertures. The outer retaining screen is positioned adjacent to and is in fluid communication with the inlet surface. At least one of the inner or outer retaining screens comprises a thermoplastic polymer.

In one form of this embodiment of the present invention, the air filter includes only an inner retaining screen that extends between the first and second end caps and is positioned adjacent to the outlet surface of the air filter. The inner retaining screen comprises a thermoplastic polymer and defines a plurality of apertures. In another form of this embodiment of the present invention, the air filter includes only an outer retaining screen that extends between the first and second end caps and is positioned adjacent to the inlet surface of the air filter. The outer retaining screen comprises a thermoplastic polymer and defines a plurality of apertures.

The present invention also provides a retaining screen for use with an air filter, the retaining screen comprising a thermoplastic polymer netting material having a top and a bottom surface that together define a plurality of corresponding apertures and are adapted to be maintained in fluid communication with and positioned adjacent to the outlet surface of the air filter's filter medium.

The present invention further provides a retaining structure for use with an air filter, the retaining structure including at least one of a first and a second retaining screen that extends between the air filter's first and second end caps. The first retaining screen defines a plurality of apertures and is adapted to be maintained in fluid communication with and positioned adjacent to the inlet surface of the air filter. The second retaining screen also defines a plurality of apertures and is adapted to be maintained in fluid communication with and positioned adjacent to the outlet surface. At least one of the first and second retaining screens comprise a thermoplastic polymer.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an automobile including an embodiment of the air filter of the present invention;

FIG. 2 is a perspective view of an embodiment of the air filter shown in FIG. 1, the air filter including a thermoplastic polymer retaining screen;

FIG. 3 is an enlarged partial cross-sectional view, taken along line 2-2 of FIG. 2, of the embodiment of the air filter shown in FIG. 2;

FIG. 4 is a perspective view of another embodiment of the air filter of the present invention, and the air filter includes inner and outer thermoplastic polymer retaining screens;

FIG. 5 is a perspective view of one form of the embodiment of the air filter shown in FIG. 4, the air filter including an inner thermoplastic polymer retaining screen;

FIG. 6 is a perspective view of another form the of the embodiment of the air filter shown in FIG. 4, the air filter including an outer thermoplastic polymer retaining screen;

FIG. 7 is a perspective view of alternative embodiments of the thermoplastic polymer retaining screen of the present invention; and

FIG. 8 illustrates enlarged cross-sectional views, taken along lines 3-3 of FIGS. 5A, 5B and 5C, of alternative embodiments of the thermoplastic polymer retaining screen of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

The system that allows air and fuel into the IC engine of an automobile is known as the intake system. The intake system generally includes an air filter, an intake manifold and a throttle body along with pressurized fuel injectors. A fresh air stream enters the IC engine through the air filter.

An air filter for an IC engine includes an inlet end through which air is drawn into the air filter and an outlet end that is in fluid communication with the intake manifold, the structure which directs a mix of air and fuel to an intake port for each cylinder of the automobile's engine. The inlet end of the air filter is typically “upstream” of the outlet end, i.e., the inlet end is positioned closer to the source of the air stream than the outlet end is positioned. The source of the air stream is the location at which air enters the engine of the automobile. The outlet end of the air filter is accordingly “downstream” of the inlet end, i.e., the outlet end is positioned away from the source of the air stream. The air stream is ducted through an air passage from the air filter to the intake manifold.

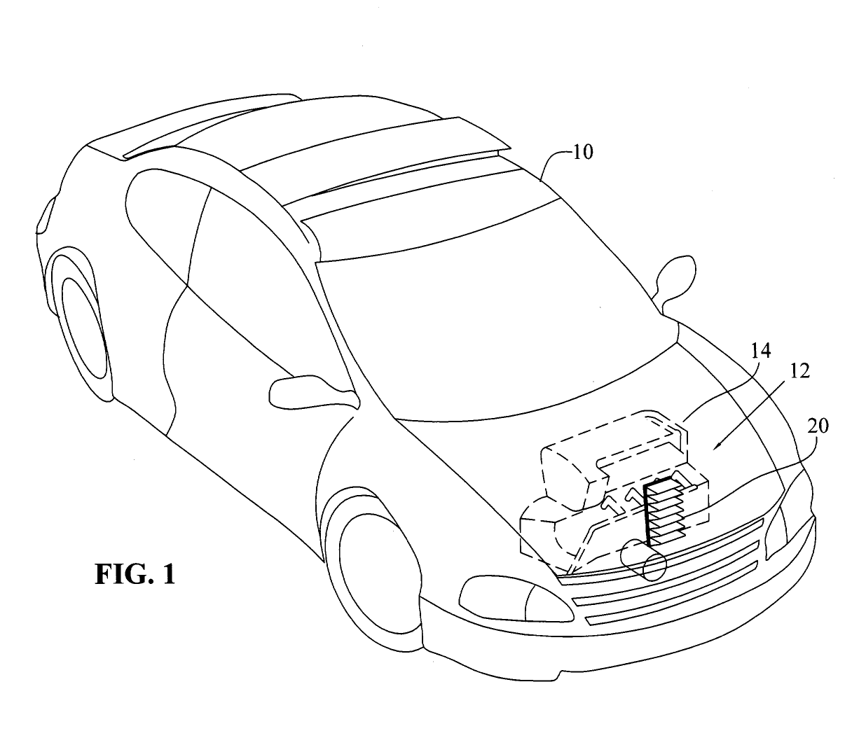

With reference to the drawings, the retaining screen and the air filter of the present invention are shown. Referring to FIG. 1, automobile 10 is shown as an illustrative use of the IC combustion engine air filter of the present invention and includes intake system 12. Intake system 12 includes air filter 20 of the present invention and an intake manifold (not shown). As described above and in general terms, an air stream is drawn towards IC engine 14 through air filter 20, flows into the intake manifold and eventually is directed to the cylinders of automobile's 10 IC engine 14.

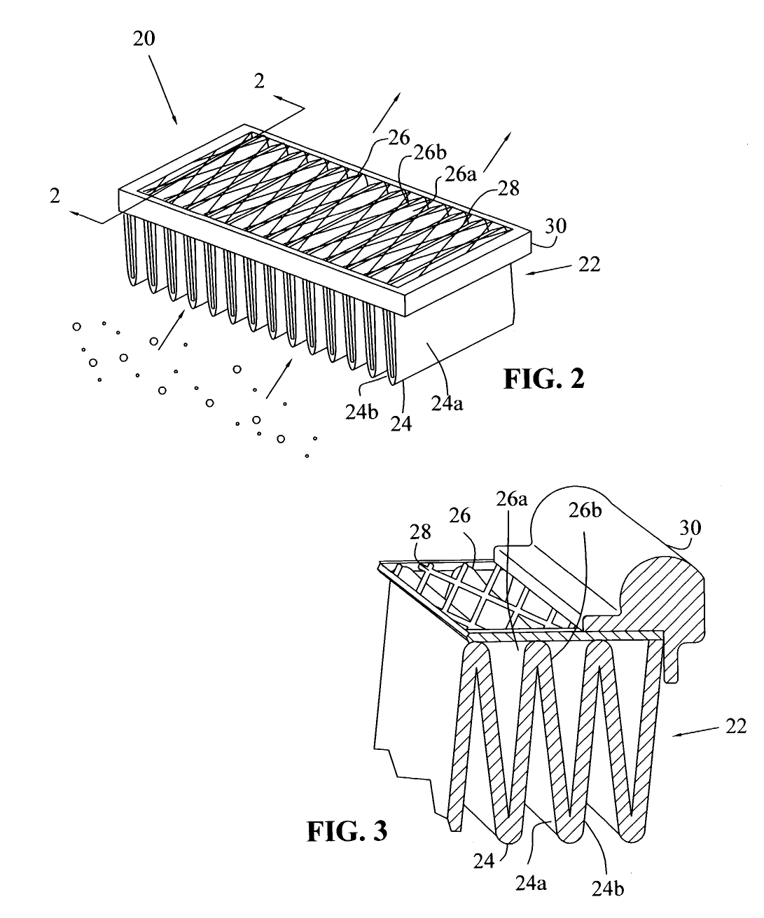

One embodiment of the air filter of the present invention is shown in greater detail in FIG. 2. Air filter 20 is generally rectangular and three-dimensional in shape and is adapted for use with an IC engine. When used in reference to an air filter, the term “adapted” herein means that the air filter is suitable for use in and made to fit the specifications of the device in which it is to be placed. When used in reference to a retaining screen, the term “adapted” herein means that the retaining screen is suitable for use in and made to fit the specifications of the air filter in which it is used. Air filters that may use the retaining screen of the present invention may be found in IC engines for air compressors, prime and standby power generators, pumps, chillers, blowers, automotive motors, locomotive engines, marine engines, and light-weight utility engines for use in lawn mowers and the like. Air filter 20 includes pleated filter medium 22. The use of the term “pleated” herein means that filter medium 22 has alternating ridges and grooves. Filter medium 22 removes particulate matter from the air stream as the air flows through air filter 20. Particulate matter includes dust, dirt and any other form of matter that is capable of traveling through an air stream into an IC engine.

Filter medium 22 has inlet surface 24 and outlet surface 26. Inlet surface 24 is positioned upstream of outlet surface 26. Inlet surface 24 provides multiple surfaces 24a, 24b through which air containing particulate matter may enter filter medium 22. Outlet surface 26 provides multiple surfaces 26a, 26b through which air filtered of the particulate matter exits filter medium 22 and flows to IC engine 14.

Retaining screen 28 is positioned adjacent to outlet surface 26 and is in fluid communication with outlet surface 26. The use of the phrase “in fluid communication” hereinafter means that a gaseous mixture, e.g., air, is capable of flowing from one structure to another structure. In the present case, filtered air is capable of flowing from outlet surface 26 to retaining screen 28. Retaining screen 28 helps to strengthen air filter 20 while contributing a small but tolerable impedance to the flow of air through air filter 20.

Retaining screen 28 is made of a thermoplastic polymer. Retaining screen 28 also defines a plurality of apertures through which filtered air flows from outlet surface 26 of filter medium 22 to IC engine 14 of automobile 10 (FIG. 1). Thermoplastic polymers suitable for making retaining screen 28 include polypropylene, polyethylene, nylon, and other such thermoplastic materials.

Retaining screen 28 may be made by extrusion. “Extrusion” is a process of converting a raw material, e.g., a thermoplastic polymer, into a finished product or part, e.g., a retaining screen. Extrusion is a known method of plastic fabrication and generally consists of melting a raw material, forcing the raw material through an opening in a die, and cooling and collecting the melt. Other methods of producing retaining screen 28, such as injection molding, are also possible. “Injection molding” is a known method of plastic fabrication that generally consists of melting a raw material and forcing the raw material through an opening into a cold mold. The mold cools the melt and shapes it into a finished product.

Referring again to FIG. 2, air filter 20 further includes maintaining means 30 for maintaining retaining screen 28 in fluid communication with outlet surface 26. Maintaining means 30 may be a resilient mold gasket or other form of seal or sealant known to those of ordinary skill in the art. Resilient mold gasket 30 borders filtering medium 22 and provides a tight seal with a ducted air passage to ensure that only filtered air escapes outlet surface 26 and reaches IC engine 14. Retaining screen 28 also may be secured directly to outlet surface 26 of filter medium 22, for example, by the use of glue.

A partial cross-section of air filter 20, taken along lines 2-2 of FIG. 2, is shown in FIG. 3. Mold gasket 30 is shown maintaining retaining screen 28 adjacent to outlet surface 26 of filter medium 22. A portion of retaining screen 28 is imbedded within mold gasket 30. Mold gasket 30 may also be secured to either a top surface of retaining screen 28, a side surface of filter medium 22, or both.

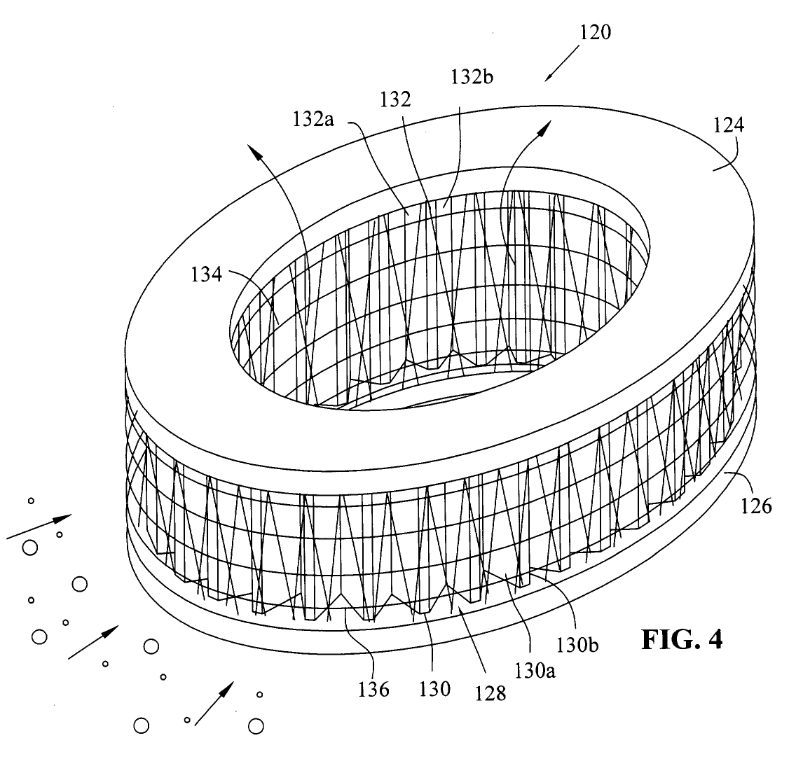

Another embodiment of the air filter of the present invention is shown in FIG. 4. Air filter 120 is generally elliptical and three-dimensional in shape and adapted for use in an IC engine. Air filter 120 includes first and second end caps 124, 126. First and second end caps 124, 126 may be resilient mold gaskets or other forms of seals known to those of ordinary skill in the art. First and second end caps 124, 126 border filtering medium 128 and provide a tight seal with a ducted air passage to ensure that only filtered air escapes outlet surface 132 and reaches IC engine 14 of automobile 10 (FIG. 1).

Air filter 120 also includes pleated filter medium 128 which substantially extends between first end cap 124 and second end cap 126. Filter medium 128 removes particulate matter from an air stream as the air flows through air filter 120. Filter medium 128 has inlet surface 130 and outlet surface 132. Inlet surface 130 is positioned upstream of outlet surface 132 and provides multiple surfaces 130a, 130b through which air containing particulate matter may enter filter medium 128. Outlet surface 132 provides multiple surfaces 132a, 132b through which air filtered of the particulate matter exits filter medium 128 and flows to IC engine 14.

Air filter 120 further includes inner and outer retaining screens 134, 136, both of which extend between first and second end caps 124, 126. Inner and outer retaining screens 134, 136 help to retain filter medium 128 within air filter 120. Inner and outer retaining screens 134, 136 also help to strengthen air filter 120 without impeding the flow of air through air filter 120. Inner retaining screen 134 is positioned adjacent to outlet surface 132 and is in fluid communication with outlet surface 132. Inner retaining screen 134 may be secured directly to outlet surface 132, for example, by the use of glue. Outer retaining screen 136 is positioned adjacent to and is in fluid communication with inlet surface 130, and outer retaining screen 136 may be secured directly to outlet surface 132. At least one of inner retaining screen 134 and outer retaining screen 136 is made of a thermoplastic polymer, and both inner retaining screen 134 and outer retaining screen 136 define a plurality of apertures through which air flows.

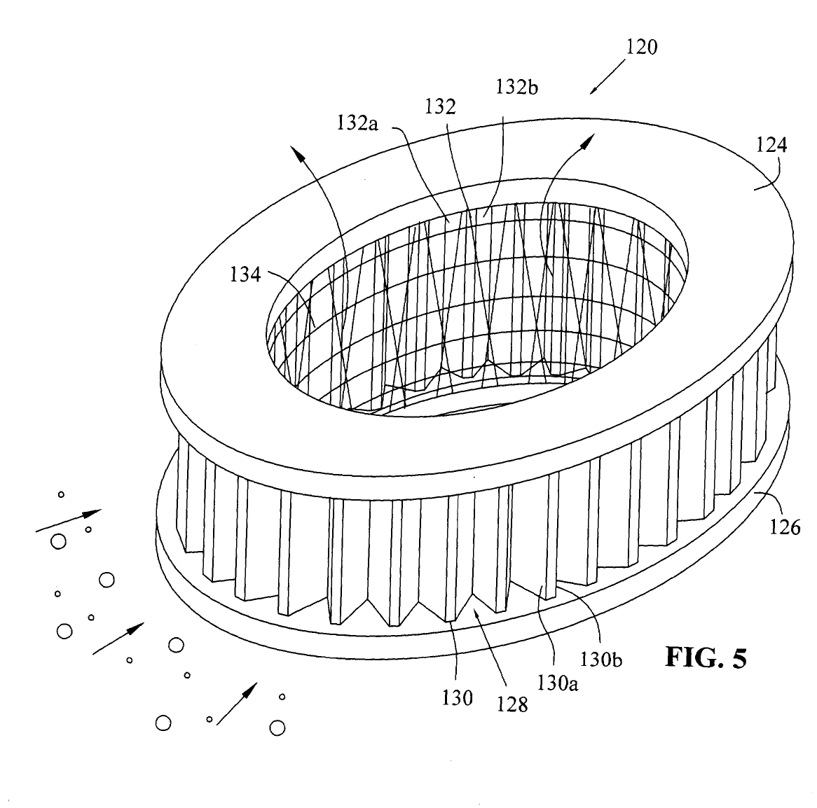

One form of this embodiment of the present invention is shown in FIG. 5. Air filter 120 is generally elliptical and three-dimensional in shape and adapted for use in an IC engine. Air filter 120 includes first and second end caps 124, 126, which may be resilient mold gaskets or other forms of seals known to those of ordinary skill in the art. First and second end caps 124, 126 border filtering medium 128. Air filter 120 also includes pleated filter medium 128 which substantially extends between first end cap 124 and second end cap 126. Filter medium 128 has inlet surface 130 and outlet surface 132. Inlet surface 130 is positioned upstream of outlet surface 132 and has multiple surfaces 130a, 130b through which air enters filter medium 128, and outlet surface 132 has multiple surfaces 132a, 132b through which filtered air exits filter medium 128.

As shown in FIG. 5, air filter 120 further includes inner retaining screen 134, which extends between first and second end caps 124, 126. Inner retaining screen 134 helps to retain filter medium 128 within air filter 120 and to strengthen air filter 120 without impeding the flow of air through air filter 120. Inner retaining screen 134 is positioned adjacent to outlet surface 132 and is in fluid communication with outlet surface 132. Inner retaining screen 134 defines a plurality of apertures and is made of a thermoplastic polymer.

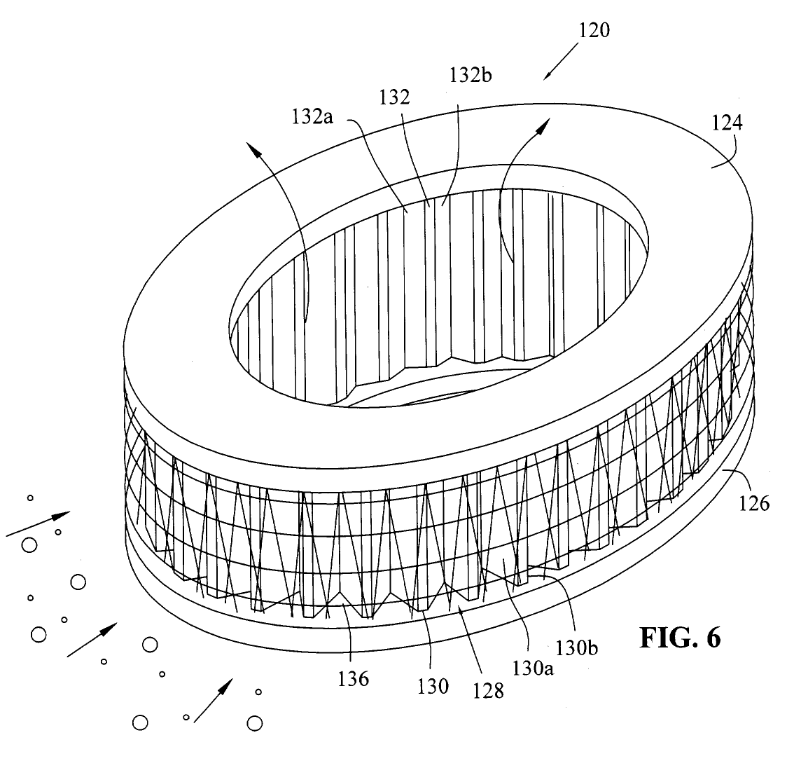

In another form of this embodiment of the present invention shown in FIG. 6, air filter 120 is generally elliptical and three-dimensional in shape and adapted for use in an IC engine. Air filter 120 includes first and second end caps 124, 126, which may be resilient mold gaskets or other forms of seals known to those of ordinary skill in the art. First and second end caps 124, 126 border filtering medium 128. Air filter 120 also includes pleated filter medium 128 which substantially extends between first end cap 124 and second end cap 126. Filter medium 128 has inlet surface 130 and outlet surface 132. Inlet surface 130 is positioned upstream of outlet surface 132 and has multiple surfaces 130a, 130b through which air enters filter medium 128, and outlet surface 132 has multiple surfaces 132a, 132b through which filtered air exits filter medium 128.

Shown in FIG. 6, air filter 120 also includes outer retaining screen 136, which extends between first and second end caps 124, 126. Outer retaining screen 136 helps both to retain filter medium 128 within air filter 120 and to strengthen air filter 120 without impeding the flow of air through air filter 120. Outer retaining screen 136 is positioned adjacent to inlet surface 130 and is in fluid communication with inlet surface 130. Outer retaining screen 136 also defines a plurality of apertures and is made of a thermoplastic polymer.

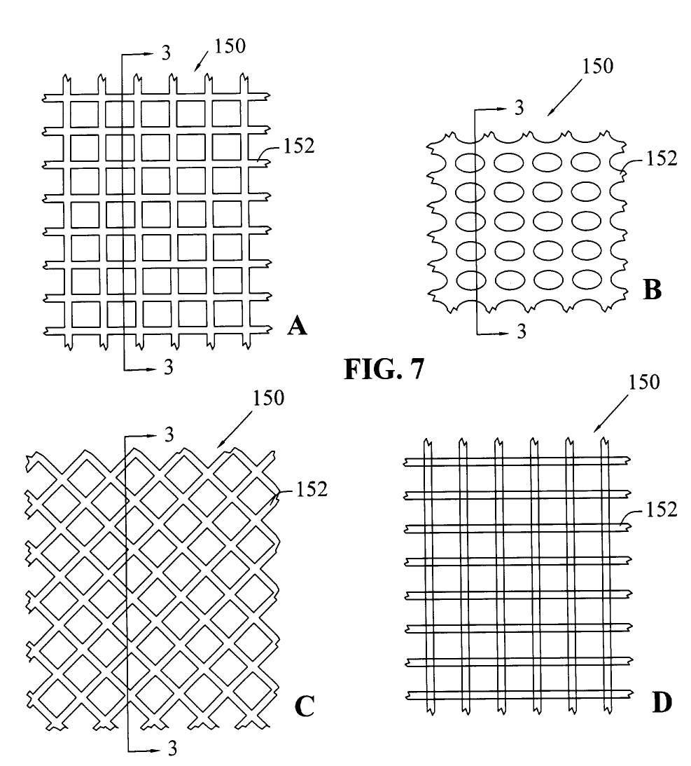

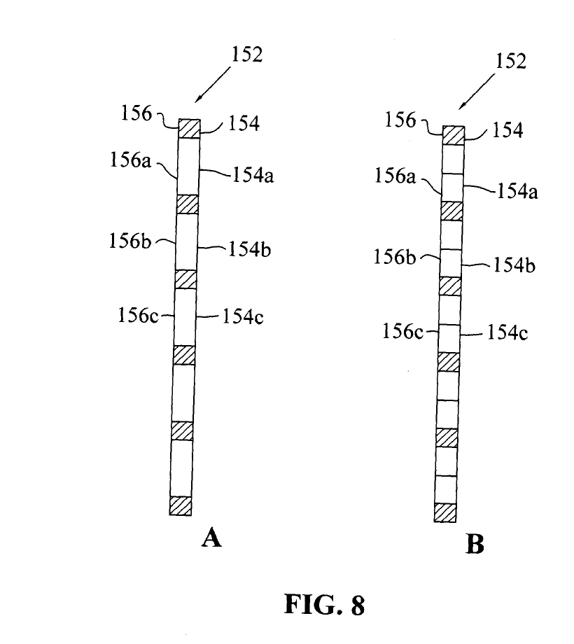

A polymeric retaining screen adapted for use with air filter 20 of the present invention is illustrated in non-limiting alternative forms in FIGS. 7A-7D. Referring to FIG. 7A, retaining screen 150 includes netting material 152 made of a thermoplastic polymer. “Netting material” is hereinafter defined as an openwork structure, i.e., a structure containing numerous openings. Netting material 152 has top and bottom surfaces 154, 156 (FIG. 8) that together define a plurality of corresponding apertures so that air may flow through netting material 152. Netting material 152 is also adapted to be maintained adjacent to outlet surface 26 so as to be in fluid communication with outlet surface 26 of filter medium 22.

A retaining structure adapted for use with air filter 120 of the present invention is also illustrated in exemplary alternative forms in FIGS. 7A-7D. Any of the retaining screens illustrated in FIGS. 7A-7D as well as other equivalent configurations may be used with air filter 120 to serve as inner, or outer, or both retaining screens 134, 136. Referring to FIG. 7A, retaining structure 150 includes netting material 152. Netting material 152 extends between first end cap 124 and second end cap 126. Depending on its use in air filter 120, netting material 152 is either adapted to be maintained in communication with and positioned adjacent to inlet surface 130 or adapted to be maintained in communication with and positioned adjacent to outlet surface 132.

As previously stated, alternate forms in which retaining screen 28 or at least one of inner and outer retaining screens 134, 136 may be provided is illustrated in FIGS. 7A-7D. As shown in FIG. 8A, a cross-sectional view taken along line 3-3 of netting material 152 (FIG. 7A), netting material 152 has top surface 154 and bottom surface 156 that together define a plurality of corresponding apertures 154a, 156a; 154b, 156b; 154c, 156c, etc. so that air may flow through netting material 152. Corresponding apertures 154a, 156a; 154b, 156b; 154c, 156c, etc. are squared-shaped.

In another form of the retaining screen of the present invention shown in FIG. 7B, retaining screen 28 or at least one of inner and outer retaining screens 134, 136 include(s) netting material 152. As shown in FIG. 8A, a cross-sectional view taken along line 3-3 of netting material 152 (FIG. 7B), netting material 152 has top surface 154 and bottom surface 156 that together define a plurality of corresponding apertures 154a, 156a; 154b, 156b; 154c, 156c, etc. so that air may flow through netting material 152. Corresponding apertures 154a, 156a; 154b, 156b; 154c, 156c, etc. are elliptically-shaped.

In still another form of the retaining screen of the present invention shown in FIG. 7C, retaining screen 28 or at least one of inner and outer retaining screens 134, 136 include(s) netting material 152. As shown in FIG. 8B, a cross-sectional view taken along line 3-3 of netting material 152 (FIG. 7C), netting material 152 has top surface 154 and bottom surface 156 that together define a plurality of corresponding apertures 154a, 156a; 154b, 156b; 154c, 156c, etc. so that air may flow through netting material 152. Corresponding apertures 154a, 156a; 154b, 156b; 154c, 156c, etc. are diamond-shaped.

In yet another form of the retaining screen of the present invention shown in FIG. 7D, retaining screen 28 or at least one of inner and outer retaining screens 134, 136 include(s) netting material 152. Netting material 152 has a top surface lain over a bottom surface, and together the top and bottom surfaces define a plurality of apertures so that air may pass through netting material 152. The apertures 154a, 156a; 154b, 156b; 154c, 156c, etc. are square-shaped.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An air filter comprising:
a filter medium having an inlet surface and an outlet surface, the inlet surface defining multiple pleats and positioned upstream of the outlet surface; and
a retaining screen comprising a thermoplastic polymer, said retaining screen defining a plurality of apertures and adjacent to and in fluid communication with the outlet surface.

2. The air filter of claim 1 wherein said retaining screen is made by extrusion.

3. The air filter of claim 1 wherein said retaining screen is made by injection molding.

4. The air filter of claim 1 wherein at least one mold gasket has a portion of said retaining screen imbedded within the mold gasket.

5. The air filter of claim 1 wherein said retaining screen is secured directly to the outlet surface.

6. The air filter of claim 1 wherein said air filter is suitable for use in an automobile having an internal combustion engine.

7. An air filter comprising:
first and second end caps;
a filter medium substantially extending between said first and second end caps, said filter medium having an inlet and an outlet surface, the inlet surface defining multiple pleats and positioned upstream of the outlet surface; and
at least one of an inner and an outer retaining screen extending between said first and second end caps, said inner retaining screen defining a plurality of apertures and adjacent to and in fluid communication with the outlet surface, and said outer retaining screen defining a plurality of apertures and adjacent to and in fluid communication with the inlet surface, at least one of said inner and outer retaining screens comprising a thermoplastic polymer.

6. The air filter of claim 5 wherein at least one of said first and second end caps is a mold gasket.

7. The air filter of claim 5 wherein at least one of said inner and outer retaining screens is made by extrusion.

8. The air filter of claim 5 wherein at least one of said inner and outer retaining screens is made by injection molding.

9. The air filter of claim 5 wherein said inner retaining screen is secured directly to the outlet surface.

10. The air filter of claim 5 wherein said outer retaining screen is secured directly to the inlet surface.

11. The air filter of claim 5 wherein said air filter is suitable for use in an automobile having an internal combustion engine.

12. A retaining screen adapted for use with an air filter, the air filter including a filter medium having an inlet and an outlet surface, the inlet surface defining multiple pleats and positioned upstream of the outlet surface, said retaining screen comprising:
a netting material comprising a thermoplastic polymer and having a top and a bottom surface, said top and bottom surfaces together defining a plurality of corresponding apertures and adapted to be maintained in fluid communication with the outlet surface of the filter medium.

13. The retaining screen of claim 12 wherein said retaining screen is made by extrusion.

14. The retaining screen of claim 12 wherein said retaining screen is made by injection molding.

15. The retaining screen of claim 12 wherein the air filter is suitable for use in an automobile having an internal combustion engine.

16. A retaining structure adapted for use with an air filter, the air filter including first and second end caps and a filter medium substantially extending between the first and second end caps, the filter medium having an inlet and an outlet surface, the inlet surface defining multiple pleats and positioned upstream of the outlet surface, said retaining structure comprising:
at least one of a first and a second retaining screen extending between the first and second end caps, said first retaining screen defining a plurality of apertures and adapted to be maintained in fluid communication with the inlet surface, and said second retaining screen defining a plurality of apertures and adapted to be maintained in fluid communication with the outlet surface, at least one of said first and second retaining screens comprising a thermoplastic polymer.

17. The retaining structure of claim 16 wherein at least one of said retaining screens is made by extrusion.

18. The retaining structure of claim 16 wherein at least one of said retaining screens is made by injection molding.

19. The retaining structure of claim 16 wherein the air filter is suitable for use in a automobile having an internal combustion engine.
